(19) United States
(12) Patent Application Publication
(10) Pub. No.: US 2025/0352861 A1
(43) Pub. Date: Nov. 20, 2025

(54) Noise Reduction Pickleball

(71) Applicants: James Lawrence Wagner, Manhattan Beach, CA (US); Justin Miles Discoe, Lee, NH (US)

(72) Inventors: James Lawrence Wagner, Manhattan Beach, CA (US); Justin Miles Discoe, Lee, NH (US)

(21) Appl. No.: 18/669,453

(22) Filed: May 20, 2024

(51) Int. Cl. A63B 37/00; A63B 37/12; A63B 102/08; C09D 109/00; C09D 121/00; C09D 175/04; C09J 7/00

(52) U.S. Cl. CPC A63B 37/0098; A63B 37/12; C09D 109/00; C09D 121/00; C09D 175/04; C09J 7/00; A63B 2102/08; A63B 2209/00

(57) ABSTRACT

A ball used for certain practice and sporting events for the game of pickleball where the ball comprises a plastic outer shell having at least one opening where the openings or coatings may include dampening properties that reduce the noise when the ball impacts a paddle, or the court surface/ground. The ball may be spherical, hollow shell ball with at least one opening. The ball may have at least one opening where the shape of the opening comprises a hole with a slot intersecting the hole. Also, the openings in the ball may have tapered edges, rounded and/or stair stepped edges. Also, the exterior of the ball may have a dampening tape or coating applied to the interior or exterior of the ball.

### BACKGROUND OF THE INVENTION

### 1. Claim of Priority

This application claims priority to U.S. Provisional Patent Application No. 63/504,258 filed on May 25, 2023, titled “Quieter Pickleball” and U.S. Provisional Application No. 63/585,422 filed on Sep. 26, 2023, titled “Quieter Pickleball;” both of which are incorporated by reference in their entirety.

### 2. FIELD OF THE INVENTION

This invention provides a ball design that reduces noise as the ball moves through air or is impacted by objects. Specifically, the ball may be used in certain sporting and recreational events where noise may be a distraction or detrimental side effect.

### 3. Related Art

The sport of pickleball is rapidly growing in popularity, namely because it provides social benefits in addition to health benefits and can utilize existing tennis courts if regulation pickleball courts are not available. According to Pickleball's Official Rules, the balls used in pickleball have between 26 to 40 circular holes with hole spacing and overall design conforming to the flight characteristics. Also, the ball must have the manufacturer's or supplier's name or logo printed or embossed on the ball's surface. Typically, balls used in pickleball matches have larger holes for indoor play and smaller holes for outdoor play. All approved balls are listed on the USA Pickleball's website.

Pickleballs typically have a plurality of holes ranging from between 26 and 40 through-holes. Some pickleballs designed for outdoor play have 40 holes, while some pickleballs designed for indoor play have only 26 holes. In some instances, hybrid pickleballs have 32 holes. These openings can be evenly spaced around the ball and/or can be arranged in a uniform pattern and/or have uniform distribution. The pickleball can have an equal quantity of holes on either side of the parting line which is also known as an equator. The holes can be formed during molding or after molding of the ball, such as by drilling or with a CNC machine. The holes can reduce the overall mass of the ball, reduce impact on the racket for the player(s), and/or assist with airflow (e.g., by creating turbulence) for improved flight. In some embodiments, the holes are circular in shape.

Pickleball is played by hitting a hollow ball over a net with a paddle. A leading complaint about pickleball is the noise level created when the ball hits an object such as the paddle, pickleball court surface, or an object. The impact noise of a pickleball is much louder than the impact of tennis balls, so much so that communities of houses and residential buildings nearby pickleball courts often complain about the noise.

Some variants of plastic hollow ball manufacturing start with a two-piece hemispherical, hollow construction. These two semispherical halves may be injection-molded and joined at a parting line to form a sphere, typically through ultrasonic welding. The parting line is often visible on the ball and is often referred to as the ball's equator. The parting line can have a local increase in thickness of the shell's wall compared to the rest of the ball; and in some instances, can create uneven weight distribution, and/or can produce a stiffened spine in the ball. Such uneven wall thickness and weight cause less predictable ball flight, bounce, and striking characteristics, or otherwise decrease the ball's performance. Certain variants of the ball may be manufactured using a one-piece construction constructed with rotational molding. One-piece construction can avoid the creation of a parting line in the ball and the associated performance concerns.

There have been attempts to quell the noise with sound-reducing paddles and sound-absorbing padded fences that surround sporting courts and fields. Neither option provides satisfactory solutions. Sound-reducing paddles are costly requiring special equipment, driving some players out of the game based on the cost of expensive special paddles if required to play on certain courts and fields. Additionally, special paddles can provide performance advantages to certain players, which decreases the fun, fairness, and inclusivity of the sport. Meanwhile sound-absorbing fencing is often unsightly, expensive, and negatively impacts the overall enjoyment of playing these sports outdoors.

A need exists for a noise reducing ball such that when the plastic ball moves through the air or impacts an object, the ball retains key performance characteristics such as trajectory and bounce, while minimizing its noise generating side effects. Modifying the ball design slightly to reduce noise benefits all players and observers of the sport. By overcoming this shortcoming, the pickleball can reduce a major disadvantage of noise of play, while retaining core benefits sought by enthusiasts.

### SUMMARY

A ball used for the game of pickleball where the ball comprises a plastic outer shell having at least one opening where the openings or coatings may include dampening properties that reduce the noise when the ball impacts a paddle, or the court surface/ground. The ball may be spherical, hollow shell with at least one opening. The ball may have at least one opening where the shape of the opening comprises a hole with a slot intersecting the hole. In the alternative, these shape features may include openings with multiple slots, star shaped openings, asterisk shape openings, triangular shaped openings, X shaped openings where two slots intersect, or an opening where two slots touch each other forming a T shape. Also, the openings in the ball may have tapered edges, rounded and/or stair stepped edges. Also, the exterior of the ball may have a dampening tape or coating applied to the interior or exterior of the ball.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

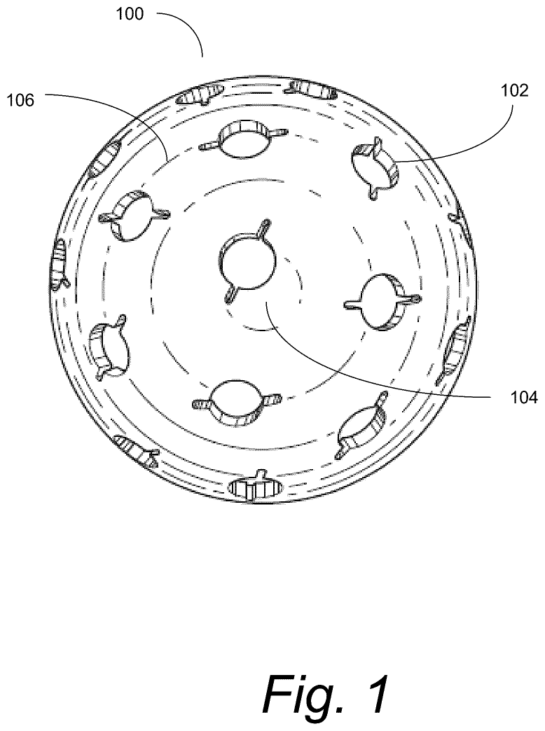

FIG. 1 is a side view of a ball illustrating the ball's plurality of openings.

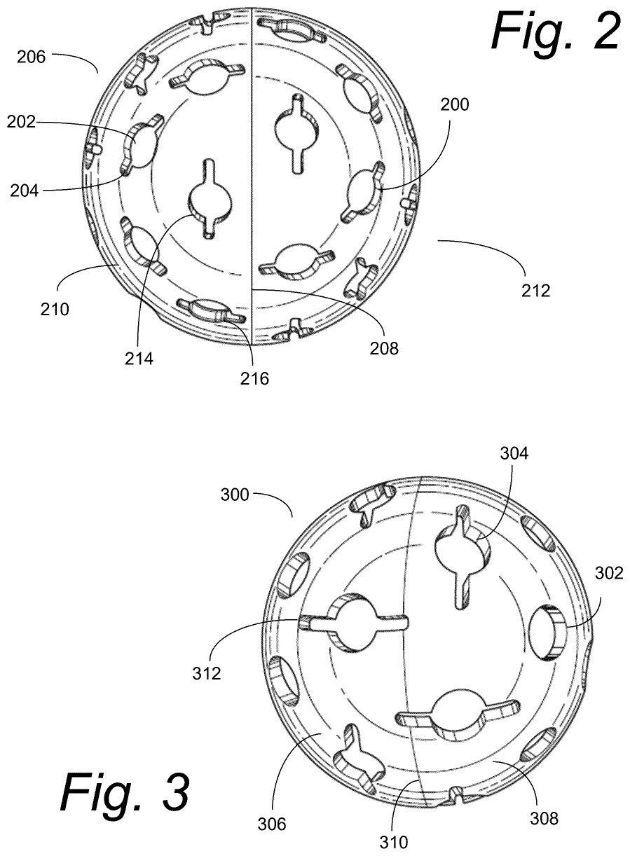

FIG. 2 is a side view of a ball illustrating the ball's plurality of openings and a left and right hemispherical parts.

FIG. 3 is an off-center side view of a ball illustrating the ball's plurality of openings and a left and right hemispherical parts.

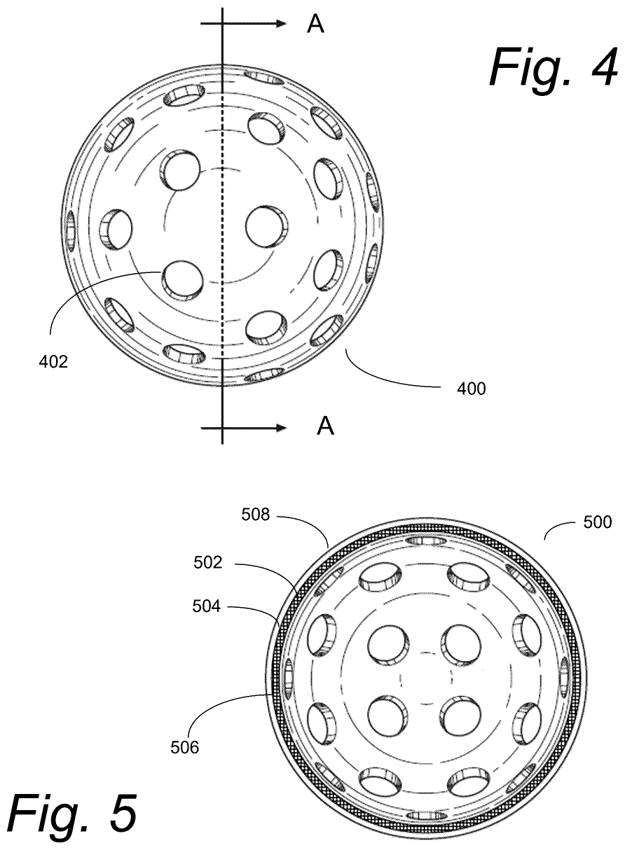

FIG. 4 is a front view of a ball illustrating the ball's plurality of openings.

FIG. 5 is an interior view of a ball cut along the “A” axis of FIG. 4 illustrating the ball's plurality of openings.

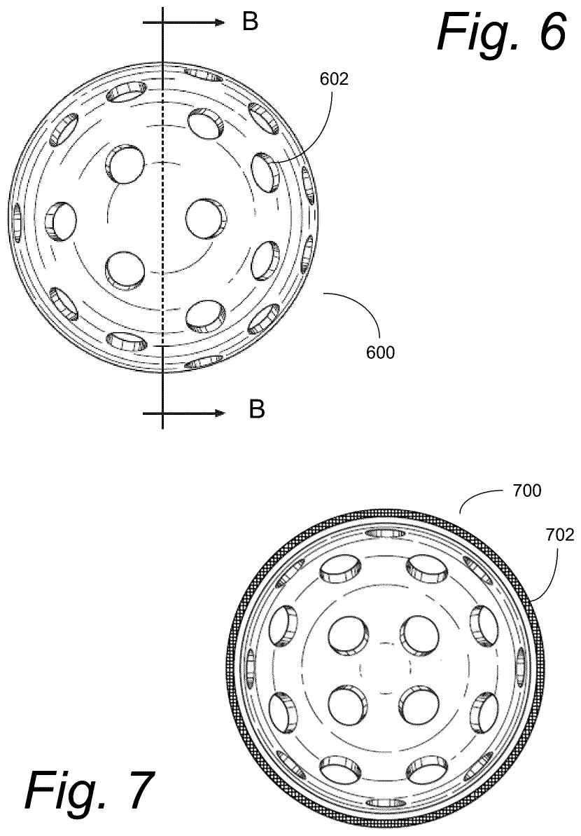

FIG. 6 is a front view of a ball illustrating the ball's plurality of openings and a left and right hemispherical parts.

FIG. 7 is an interior view of a ball cut along the “B” axis of FIG. 6 illustrating the ball's plurality of openings.

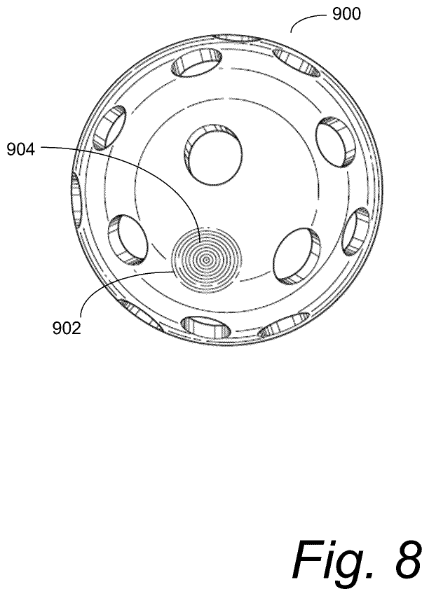

FIG. 8 is a front view of a ball illustrating the ball's plurality of openings and a dimple filled in with a sound dampening compound.

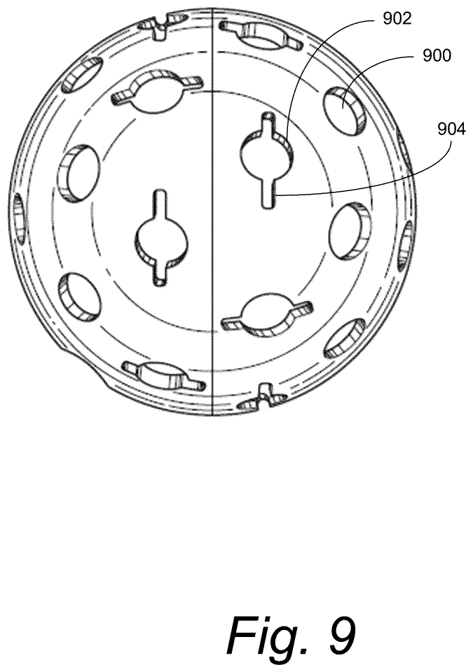

FIG. 9 is a front view of a ball illustrating the ball's plurality of openings and a left and right hemispherical parts.

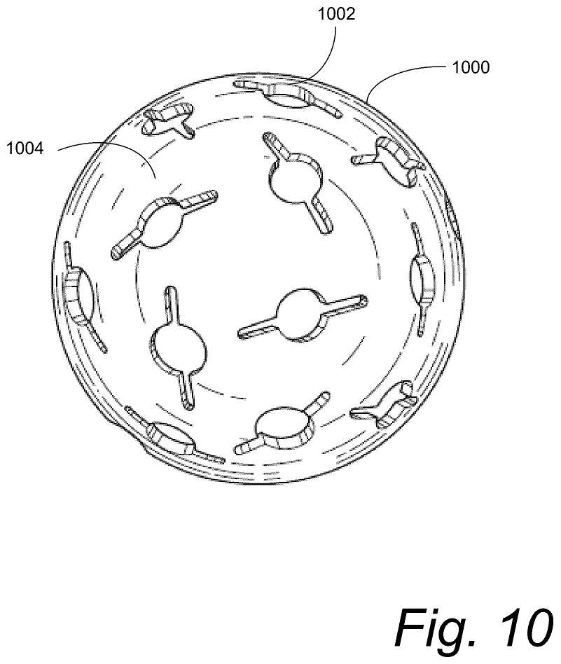

FIG. 10 is a front view of a ball illustrating the ball's plurality of openings.

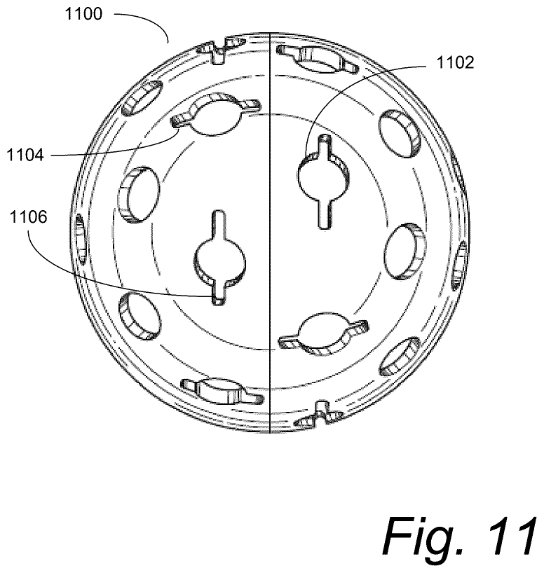

FIG. 11 is a front view of a ball illustrating the ball's plurality of openings.

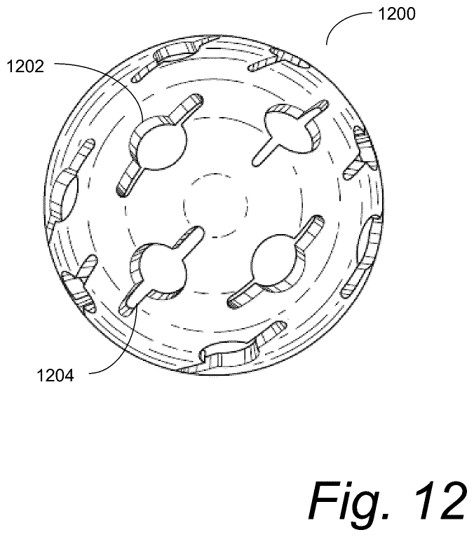

FIG. 12 is a side view of a ball illustrating the ball's plurality of openings relative to the ball's equator.

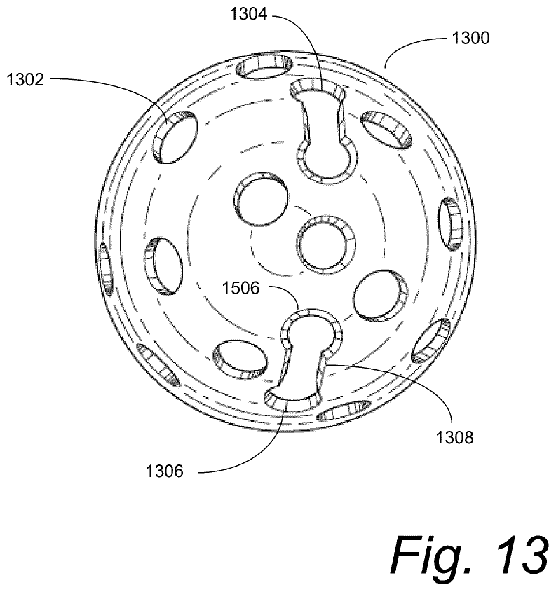

FIG. 13 is a front view of a ball illustrating the ball's plurality of openings with the hole and slot configuration such that the slots are all parallel to each other.

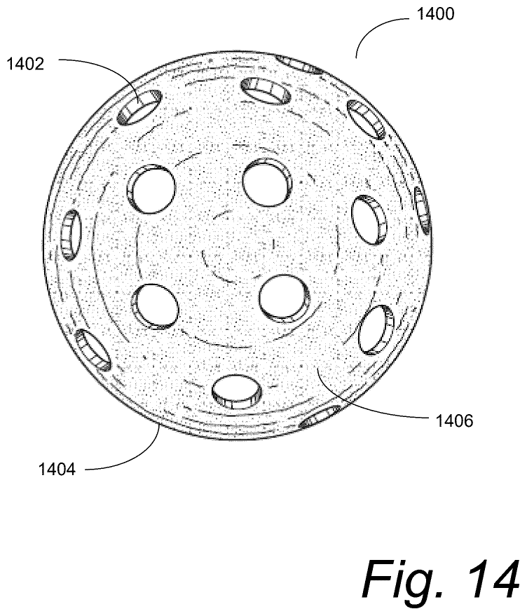

FIG. 14 is a front view of a ball illustrating the ball's plurality of openings having circular openings and large slots formed near the circular openings.

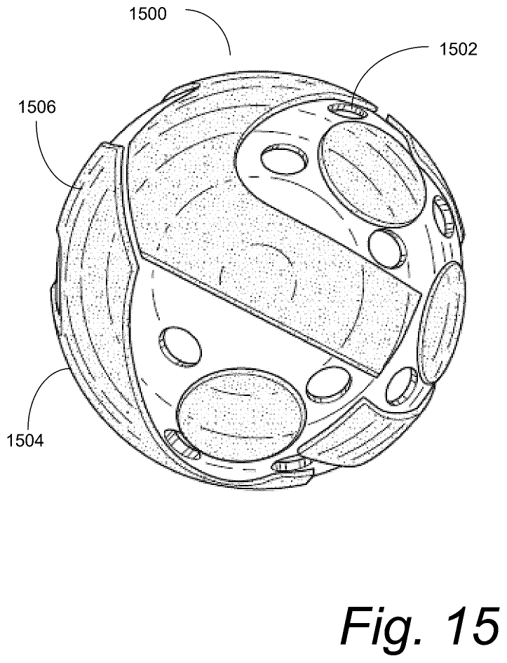

FIG. 15 is a front view of a ball illustrating the ball's plurality of openings having a rubberized outer surface.

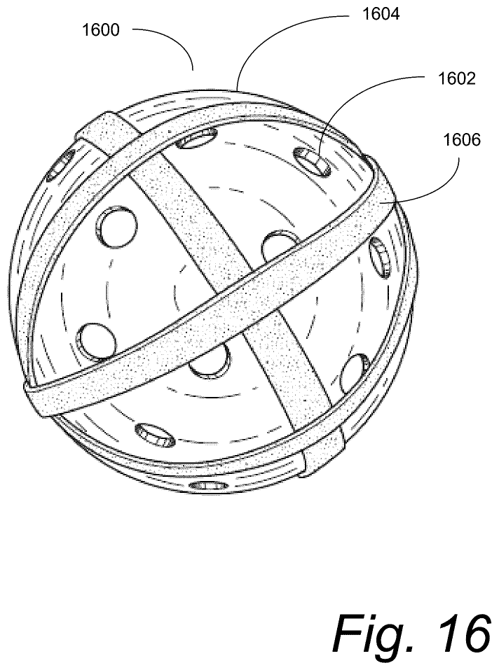

FIG. 16 is a front view of a ball illustrating the ball's plurality of openings having kinesiology tape applied to the exterior of the outer surface.

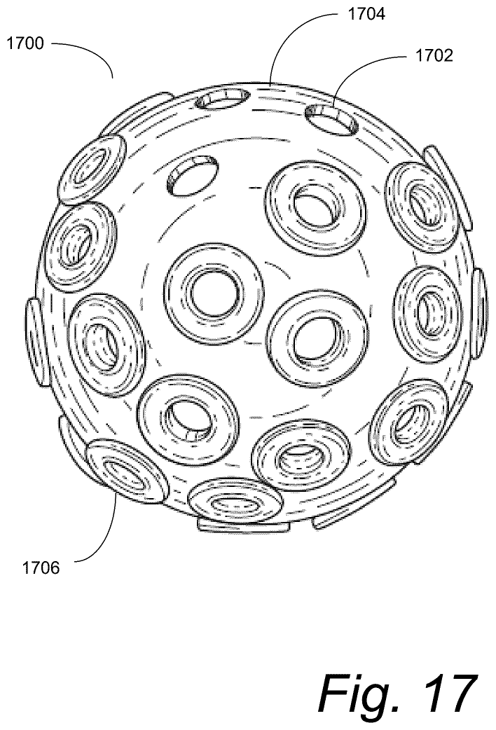

FIG. 17 is a front view of a ball illustrating the ball's plurality of openings having tape on the exterior of the outer surface in a banded arrangement.

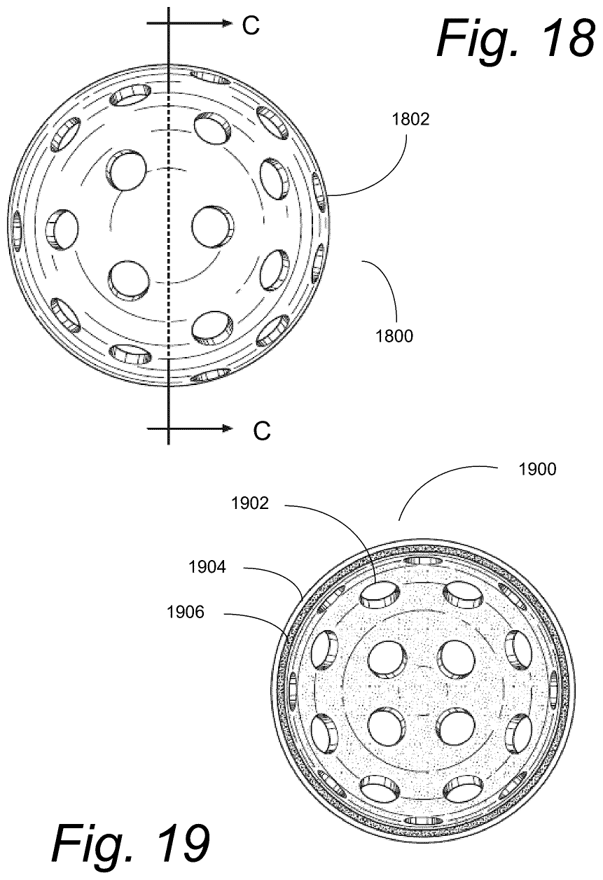

FIG. 18 is a front view of a ball illustrating the ball's plurality of openings having grommets embedded in the ball's surface.

FIG. 19 is a front view of a ball illustrating the ball's plurality of openings having a rubberized product adhering to the interior of the ball's surface.

FIG. 20 is an interior view of a ball cut along the “C” axis of FIG. 20 illustrating the ball's plurality of openings and having a rubberized product adhering to the interior of the ball's surface.

### DETAILED DESCRIPTION

The ball used in pickleball matches typically comprises a plastic hollow shell. The shell can be made of plastic, foam compound, resin, or polymer, such as low-density polypropylene (“LDPE”). For pickleball matches, the ball is spherical, hollow shell with an outside diameter of approximately 73 mm-78 mm and/or a circumference of approximately 229 mm-237 mm; weighing approximately 22.1 g-26.5 g. The ball can have a hardness of between approximately 40 and 50 on the Durometer D scale at an ambient temperature of 24-27° C. The ball can bounce approximately 76 mm-86 mm to the top of the ball when dropped from a height of approximately 198 mm onto a granite plate having a size of at least 30.5 cm by 30.5 cm having a thickness of 10.2 cm at an ambient temperature between 24-27° C.

The balls may be configured to reduce the thickness, weight, and/or stiffness of the parting line of the ball, thus reducing or eliminating such issues and/or reducing the impact and noise of the ball striking the paddle.

Holes created in the ball may be configured to create vortices, which can create forces that alter and at times improve flight characteristics of the ball. These holes create forces inside the ball that can overpower the external flight forces. These internal forces, such as those forces creating an altered air pressure inside the ball, can exert a greater force on the ball than the localized pressure on the ball's exterior.

FIG. 1 is a front view of a ball illustrating the ball's 100 plurality of openings. In FIG. 1, the hole and slot 102 features are distributed around the pole 104 one of the hemisphere's forming the ball 100. Here, the hole and slot 102 features are arranged in orbits 106 relative to the pole 104 and the ball's equator.

FIG. 1 is a side view of a ball illustrating the ball's plurality of openings and a left and right hemispherical parts. In FIG. 1, the hole and slot feature are located along and/or adjacent to the parting line and/or an equator of the ball, and one or more or all of the ball's other holes are circular. For example, as shown in FIG. 1, the holes 100 in the ball can comprise a circular component 102 plus an elongated slot component 104. In this configuration, the longitudinal axis of the slot 104 can pass through the center of the hole 102. The centerline of the slot 104 may pass through the center of the hole 100 to form the hole and slot feature. The slot 104 may also comprises an elongated slot that extends outward from (e.g., beyond) the first and second sides of the circular hole 102. This hole 102 and slot 104 feature appears in a simplified form as a silhouette image of the planet Saturn.

Shapes other than the hole and slot feature can be considered as alternatives and may work generating noise reduction when the ball impacts a paddle, or court surface/ground. These shape features may include holes with multiple slots, star shaped openings, an asterisk shape, triangular openings, X shaped openings where two slots intersect, or an opening where two slots touch each other forming a T shape. Also, holes in the ball may have tapered edges, rounded and/or stair stepped edges.

The slot of the hole and slot feature comprises an elongated hole in the wall of the pickleball. The slot can have a longitudinal axis. In some implementations, the longitudinal axis is generally parallel to a circumferential axis of the ball. In some implementations, the longitudinal axis is generally parallel to the parting line and/or equator of the ball. In some implementations, the longitudinal axis is generally perpendicular to the parting line and/or equator.

As shown in FIGS. 1 and 2, the holes and the slots can intersect. For example, the longitudinal axis of the slot can pass through the center of the hole. In various embodiments, the slot comprises an elongated slot that extends outward from (e.g., beyond) first and second sides of the circular hole.

FIG. 2 is a side view of a ball illustrating the ball's plurality of openings and a left and right hemispherical parts. In FIG. 2, all of the ball's holes comprise hole and slot 200 features where the hole 202 and slot 204 features are substantially evenly distributed around the ball 206. The equator 208 is shown illustrating the welding line where the left hemisphere 210 was joined with the right hemisphere to form the ball 206.

In certain embodiments, the hole and slot 200 feature includes multiple slots positioned in the ball 212. For example, the hole and slot 200 feature can have a first holed and slot feature 214 that is positioned in one orientation and a second hole and slot 216 feature positioned in another orientation. The first and second hole and slot features 214 and 216 can have the slots be generally parallel or angled relative to each other. The first and second hole and slot 214 and 216 features can have respective longitudinal axes that intersect, such as aligned at a generally perpendicular angle. In some variants, the slots are oriented generally parallel to the parting line and/or equator, generally perpendicular to the parting line and/or equator of the ball, or at an angle of 0° to 90° relative to the parting line and/or equator. The first and second hole and slot 214 and 216 features can also have the same size and shape or be differently sized and shaped. Thus, the slot of the hole and slot feature can be oriented in various directions.

FIG. 3 is an off-center side view of a ball illustrating the ball's 300 plurality of openings 302. In FIG. 3, both circular openings 302 and hole and slot 304 feature openings are shown in the spherical, hollow ball 300. Also, the left 306 and right hemispherical 308 parts separated by the equator 310.

As shown in FIG. 3, the ball 300 can include openings 302 where the slots are generally parallel to the ball's equator 310 and slots that are aligned generally perpendicular 312 to the equator 310. In certain configurations, the ball 300 may have sixteen (16) hole and slot 304 features along the equator 310, with eight (8) hole and slot 304 features distributed on each of the two hemispheres forming the ball 300. In other configurations, the ball may have forty (40) or more hole and slot 304 features distributed around the circumference of the ball 300, with twenty (20) hole and slot 304 features distributed on each of the two hemispheres forming the ball 300.

The hole and slot 304 features can reduce the stiffness of the ball and affect the coefficient of elasticity of the ball 300. This reduced stiffness can reduce the resonance of the ball 300 striking a paddle or bouncing on the ground and/or increase internal airflow of the ball to improve flight performance.

The ball 300 can also provide a reduced noise signature when hit by a paddle, or court surface/ground, which reduces the sound of playing the sport. Such a reduction in sound can reduce community negativity around the sport overall. Certain embodiments of the ball 300 can provide a sound reduction compared to conventional balls 300.

The variations of the ball 300 can provide the value of play-trajectory, bounce and consistency of impact, while reducing the decibel levels of traditional play in both singles and doubles. In some implementations, the hole and slot 304 feature can provide increased airflow.

FIG. 4 is a front view of a ball illustrating the ball's plurality of openings. In FIG. 4, the ball 400 shows circular openings 402 of a traditional ball. However, this traditionally appearing ball 400 is different from an interior perspective. FIG. 5 is an interior view of a ball cut along the “A” axis of FIG. 4 illustrating the ball's plurality of openings. In FIG. 5, the interior side of ball 500 is shown illustrating a sound dampening compound 502. The incorporation of a sound dampening compound 502 can reduce the audible noise generated when the ball is struck with a paddle.

A ball's internal structure can have internal structures such as honeycomb features and other features that can create air turbulence and/or interrupt pressure waves. Shallow grooves around the holes can also change the depth and shape of the opening. These grooves can create air vortices that can reduce air friction. Other internal features may include interior bumps, dimples or rough surface areas.

As shown in FIGS. 4 and 5, the ball 500 may include a dampening layer 502 deposited or formed on the inside 504 and/or outside surfaces of the ball 500. This dampening layer(s) may comprise thermoplastic polyurethane (TPU), vulcanized polybutadiene (e.g., superball material), thermoplastic rubber, rubber compound, foam compound, felt, or other materials that are well known in the art for their dampen properties. In certain variants, the dampening layer comprises a material 506 (e.g., plastic) that is softer than the material of the shell. The dampening layer 506 can have holes that correspond in size and shape to the openings, and/or holes and slot features in the ball. This dampening layer 502 may comprise a coating that is sprayed onto the interior side of the ball 500 during the manufacturing process. In some embodiments, the dampening layer 502 is co-molded with the outer shell 508. The dampening layer can have a thickness of 1.5 mm, but typically has a thickness in the range of 0.5 mm-2.5 mm.

FIG. 6 is a front view of a ball illustrating the ball's plurality of openings. In FIG. 6, the ball 600 shows circular openings 602 of a traditional ball. However, this traditionally appearing ball 600 transforms in FIG. 7 with an exterior view of the ball 700 cut along the “B” axis of FIG. 6 illustrating the ball's plurality of openings. In FIG. 7, the exterior of ball 700 is shown illustrating a sound dampening compound 702. The incorporation of a sound dampening compound 702 can reduce the audible noise generated when the ball is struck with a paddle.

FIG. 8 is a front view of a ball illustrating the ball's plurality of openings and a dimple filled in with a sound dampening compound. The ball 800 has at least one dimple 802 that was filled in with a material that is not the material comprising the composition of the ball 800. Such a material may be an elastomeric material such as a thermoplastic elastomer (TPE), vulcanized polybutadiene, thermoplastic rubber, rubber compound, foam compound, a silicon based caulk or other plasticized material that when placed in the dimple 802, the resonance of the ball 800 is dampened. As previously mentioned, when the resonance of the ball 800 is dampened, the noise generated from the impact of a paddle is lessened. The amount of material placed in the dimple 802 may be less, equal to or slightly more than the volume of the dimple 802

FIG. 9 is a side view of a ball illustrating the ball's plurality of openings and a left and right hemispherical parts. In FIG. 9, the hole and slot feature are located along and/or adjacent to the parting line and/or an equator of the ball, and one or more or all of the ball's other holes are circular. The ball 900 may include a hole 902 and slot 904 feature configuration. For example, as shown in FIG. 9, the holes in the ball can comprise a circular component 902 plus an elongated slot component 904. In this configuration, the longitudinal axis of the slot 904 can pass through the center of the hole 902, but that is not necessarily required. The slot 904 may also comprises an elongated slot that extends outward from (e.g., beyond) the first and second sides of the circular hole 902.

FIG. 10 is a front view of a ball illustrating the ball's plurality of openings. FIG. 10 shows a ball 1000 having a plurality of hole and slot 1002 features. These hole and slot 1002 features are distributed around the circumference of the ball 1000. These hole and slot 1002 features may completely penetrate the ball's outer surface 1004 or they may provide indentations such that the hole and slot 1002 features penetrate the outer surface of the ball 1000, but are not deep enough to penetrate the interior surface or side of the ball 1000.

FIG. 11 is a side view of a ball illustrating the ball's plurality of openings relative to the ball's equator. FIG. 11 illustrates the ball's 1100 hole and slot feature 1102 having thin width slots 1104 that are shorter in length than the diameter of the hole 1106. In some embodiments, the slots may be longer than the diameter of the holes 1106 (not shown).

FIG. 12 is a front view of a ball illustrating the ball's 1200 plurality of openings with the hole and slot configuration 1202 such that the slots are all parallel to each other. In FIG. 12, the ball 1200 has hole and slot features 1202 spaced apart and located around the periphery of the ball 1200 where the slots 1204 are positioned aligned in parallel planes or in the same plane relative to each other. These slots 1204 may be aligned parallel to the equator of the ball 1200, aligned perpendicular to the equator or at some angle between 0-90 degrees relative to the equator.

FIG. 13 is a front view of a ball illustrating the ball's plurality of openings in the surface of the ball 1300. FIG. 13 illustrates a ball 1300 having circular openings 1302 and large slots 1304 formed in the outer surface of the ball 1300. These large slots 1304 may be near the circular openings. The large slots 1304 may be oval (not shown) or wide slots 1306 connecting two circular openings 1308 where the slot width is the same width (not shown) or less than the diameter of the circular openings 1308. The center line of the slot 1306 can connect with the center of a first opening as well as the center of a second center of a second opening. The diameter of the opening 1304 may be greater than, less than or equal to the width of a slot 1306.

FIG. 14 is a front view of a ball illustrating the ball's plurality of openings having a rubberized outer surface. FIG. 14 illustrates a ball 1400 having a plurality of openings 1402. The openings 1402 that are shown are circular, but the openings can comprise hole and slot features (not shown). The outer surface 1404 of the ball 1400 has a rubberized plastic composition 1406 that adheres to the outer surface 1604 of the ball 1400. The rubberized plastic composition 1406 acts as a sound dampening compound to reduce the ball's ability to resonate thus generating a lower sound when hit by a paddle.

FIG. 15 is a front view of a ball illustrating the ball's plurality of openings having kinesiology tape applied to the exterior of the outer surface. The ball 1500 has a plurality of openings 1502 that are shown are circular, but the openings can comprise hole and slot features (not shown). The outer surface 1504 of the ball 1500 may include a kinesiology tape that has a rubberized, flexible plastic tape 1506 that adheres to the outer surface 1504 of the ball 1500. The rubberized plastic composition tape 1506 acts as a sound dampening compound to reduce the ball's ability to resonate thus generating a lower sound when hit by a paddle. The rubberized, flexible composition tape 1506 can wrap over openings or be designed to create unique patterns on the ball 1500 so that the openings 1502 are not covered or the covering is at least minimized.

FIG. 16 is a front view of a ball illustrating the ball's plurality of openings having a flexible tape on the exterior of the outer surface in a banded arrangement. The ball 1600 has a plurality of openings 1602 that are shown are circular, but the openings can comprise hole and slot features (not shown). The outer surface 1604 of the ball 1600 has a rubberized plastic tape 1606 that adheres to the outer surface 1604 of the ball 1600. The rubberized plastic composition tape 1606 acts as a sound dampening compound to reduce the ball's ability to resonate thus generating a lower sound when hit by a paddle. The rubberized composition tape 1606 can wrap over openings or be designed to create unique patterns on the ball 1800 so that the openings 1602 are not covered or the covering is at least minimized.

FIG. 17 is a front view of a ball illustrating the ball's plurality of openings having grommets embedded in the ball's surface. The ball 1700 has a plurality of openings 1702 that are shown are circular. The outer surface 1704 of the ball 1700 has at least one grommet 1706 that can be inserted into the ball's openings 1702. These grommets 1706 acts as a sound dampening compound to reduce the ball's ability to resonate thus generating a lower sound when hit by a paddle. The grommets 1706 can be inserted into one, more than one, or all of the openings 1702. The grommets 1706 may be formed from a soft plastic composition and inserted into the openings 1702 during manufacturing or as an aftermarket process.

FIG. 18 is a front view of a ball illustrating the ball's plurality of openings having a rubberized product adhering to the interior of the ball's surface. FIG. 18 illustrates a ball 1800 having a plurality of openings in the outer surface 1802. While appearing as a traditional ball 1800, the ball's outer shell has a plurality of layered components.

FIG. 19 is an interior view of a ball cut along the “C” axis of FIG. 18 illustrating the ball's plurality of openings and having a rubberized product adhering to the interior of the ball's surface. The ball 1900 illustrates a plurality of circular shaped openings 1902. When cut along the “C” axis of FIG. 18, the ball 1900 shows a hard plastic outer shell 1904 and a softer inner shell 1906. The inner shell 1906 may comprise one or more layers of a dampening composition. In some instances, it may be advantageous to have a plurality of different dampening compositions. These dampening compositions act to reduce the ball 1900 characteristics to resonate which when dampened, generates a lower noise when the ball 1900 is hit by a paddle.

The features disclosed can be used in pickleballs, as well as in other sports or recreational activities that involve the use of hard plastic balls and/or balls with through-holes, practice golf balls, practice baseballs, practice softballs, practice golf balls and others balls. Depending upon the sport, the ball may be hit by a paddle.

For example, in certain embodiments, as the context may permit, the term “generally parallel” can refer to something that departs from exactly parallel by less than or equal to 20 degrees and the term “generally perpendicular” can refer to something that departs from exactly perpendicular by less than or equal to 20 degrees.

While various embodiments of the invention have been described, it will be apparent to those of ordinary skill in the art that many more embodiments and implementations are possible that are within the scope of this invention.

What is claimed is:

1. A sound reducing ball, comprising:
a spherical hollow shell having interior and exterior sides; and
a plurality of holes in the spherical hollow shell where at least one of the plurality of holes further comprises an intersecting hole and slot feature formed by a centerline of the slot intersecting a center of the hole.

2. The sound reducing ball of claim 1, where each of the plurality of holes further comprises where the slots intersecting the holes are aligned parallel to each other.

3. The sound reducing ball of claim 1, where each of the plurality of holes further comprises where the slots are aligned parallel to each other.

4. The sound reducing ball of claim 1, where each of the plurality of holes further comprises a first and second hole where the slot connects the first and second holes.

5. The sound reducing ball of claim 1, where at least one of the holes form a hole and slot feature where the slot is generally parallel to the equator of the spherical, hollow shell.

6. The sound reducing ball of claim 1, where at least one of the holes form a hole and slot feature where the slot is generally perpendicular to the equator of the spherical, hollow shell.

7. The sound reducing ball of claim 1, where the spherical hollow shell has a exterior coated with a sound dampening compound.

8. The sound reducing ball of claim 7, where the sound dampening compound further comprises a thermoplastic polyurethane (TPU) compound.

9. The sound reducing ball of claim 7, where the sound dampening compound further comprises a vulcanized polybutadiene compound.

10. The sound reducing ball of claim 7, where the sound dampening compound further comprises a thermoplastic rubber compound.

11. The sound reducing ball of claim 7, where the sound dampening compound further comprises a rubber compound.

12. The sound reducing ball of claim 7, where the sound dampening compound further comprises a foam compound.

13. The sound reducing ball of claim 7, where the sound dampening compound further comprises a felt compound.

14. The sound reducing ball of claim 1, further comprising a tape adheres to the exterior side of the spherical, hollow shell.

15. The sound reducing ball of claim 14, where the tape further comprises a kinesiology tape.

16. The sound reducing ball of claim 14, where the tape further comprises a sound reducing tape material.

17. The sound reducing ball of claim 1, where the spherical, hollow shell further comprises at least one dimple that is filled with a dampening compound.

18. The sound reducing ball of claim 17, where the dampening compound is thermoplastic elastomer (TPE).

19. The sound reducing ball of claim 17, where the dampening compound is vulcanized polybutadiene.

20. The sound reducing ball of claim 17, where the dampening compound is thermoplastic rubber.

21. The sound reducing ball of claim 1, where at least one grommet is inserted into at least one of the holes in the spherical, hollow shell.

22. The sound reducing ball of claim 1, where the interior of the spherical hollow shell is coated with a sound dampening compound.

23. The sound reducing ball of claim 22, where the sound dampening compound further comprises a thermoplastic polyurethane (TPU) compound.

24. The sound reducing ball of claim 22, where the sound dampening compound further comprises a vulcanized polybutadiene compound.

25. The sound reducing ball of claim 22, where the sound dampening compound further comprises a thermoplastic rubber compound.

26. The sound reducing ball of claim 22, where the sound dampening compound further comprises a rubber compound.

27. The sound reducing ball of claim 22, where the sound dampening compound further comprises a foam compound.

28. The sound reducing ball of claim 22, where the sound dampening compound further comprises a felt compound.

29. The sound reducing ball of claim 1, where the hole and slot further comprises the slot having a longitudinal axis such that it intersects the center of the hole.

30. The sound reducing ball of claim 1, where a centerline of the slot intersects the center of the hole.

31. A sound reducing ball, comprising:
a spherical, hollow shell; and
a first hole and a second hole located in the spherical, hollow shell where a centerline of a slot intersects a center of the first hole and a center of the second hole.

32. A sound reducing pickleball, comprising:
a spherical, hollow shell having an exterior side and an interior side;
a plurality of holes in the hollow shell; and
a dampening compound positioned as an outer coating to the exterior side of the spherical, hollow shell.

33. The sound reducing pickleball of claim 32, where the dampening compound is thermoplastic elastomer (TPE).

34. The sound reducing pickleball of claim 32, where the dampening compound is vulcanized polybutadiene.

35. A sound reducing pickleball, comprising:
a spherical, hollow shell having an exterior side and an interior side;
a plurality of holes in the hollow shell; and
a dampening compound positioned as an interior coating to the interior side of the spherical, hollow shell.

36. The sound reducing pickleball of claim 35, where the dampening compound is thermoplastic elastomer (TPE).

37. The sound reducing pickleball of claim 35, where the dampening compound is vulcanized polybutadiene.

38. A sound reducing pickleball, comprising:
a spherical, hollow shell having an exterior side and an interior side;
a plurality of holes in the hollow shell; and
at least one dimple that is filled with a dampening compound.

39. The sound reducing pickleball of claim 38, where the dampening compound is thermoplastic elastomer (TPE).

40. The sound reducing pickleball of claim 38, where the dampening compound is vulcanized polybutadiene.

41. A sound reducing pickleball, comprising:
a spherical, hollow shell having an exterior side and an interior side;
a plurality of holes in the hollow shell; and
a plurality of grommets inserted into at least two of the plurality of holes.
